(19) United States
(12) Patent Application Publication
(10) Pub. No.: US 2026/0335047 A1
(43) Pub. Date: Oct. 29, 2026

(54) PALATAL EXPANDER

(71) Applicant: Sung Chul MOON, Seoul (KR)

(72) Inventor: Sung Chul MOON, Seoul (KR)

(73) Assignee: Sung Chul MOON, Seoul (KR)

(21) Appl. No.: 19/273,208

(22) Filed: Jul. 18, 2025

(30) Foreign Application Priority Data
Apr. 28, 2025 (KR) 1020250055798

(51) Int. Cl. A61C 7/10

(52) U.S. Cl. CPC A61C 7/10

(57) ABSTRACT

A palatal expander includes a pair of bone screw coupling units extending in one direction and arranged to face each other, and a driving unit disposed between the pair of bone screw coupling units. Each of the bone screw coupling units is provided with at least three bone screw holes, and the at least three bone screw holes are arranged in a crosswise manner on a plurality of virtual lines parallel to an extension direction of the corresponding bone screw coupling unit. The pair of bone screw coupling units move in one direction as at least a portion of the driving unit moves in the other direction.

### CROSS-REFERENCE TO RELATED APPLICATION

This application is based on and claims priority under 35 U.S.C. § 119 to Korean Patent Application No. 10-2025-0055798, filed on Apr. 28, 2025, in the Korean Intellectual Property Office, the disclosure of which is incorporated by reference herein in its entirety.

### FIELD OF THE DISCLOSURE

The disclosure relates to a palatal expander. More particularly, the disclosure relates to a palatal expander configured to secure structural stability and improve resistance to buckling and overturning after being implanted into the palatal bone.

### BACKGROUND

### Description of the Related Art

When the transverse width of the maxilla is smaller than that of the mandible, a condition commonly referred to as a narrow palate (roof of the mouth) may result, which is frequently observed not only in patients exhibiting malocclusion but also in the general population. In such circumstances, a posterior crossbite may develop; however, even in the absence of a posterior crossbite, it is well recognized that achieving optimal orthodontic outcomes becomes challenging if the transverse width of the maxilla is not adequately expanded during the course of treatment. To address this issue, palatal expansion techniques—aimed at widening the constricted maxilla or palate to approximate a normal anatomical dimension—have been extensively investigated in conjunction with orthodontic interventions. Notably, the application of palatal expansion dates back more than 160 years, having been first documented in an academic journal in 1860.

Early palatal expanders were typically affixed to the left and right maxillary molars and operated by applying rapid expansion forces to correct the narrow palate toward a more normal transverse dimension. Anatomically, the midline of the palate includes a structure known as the midpalatal suture (MPS), which, upon application of transverse expansion forces, undergoes separation accompanied by subsequent formation of new bone tissue, thereby increasing the width of the palate. This process is generally referred to as palatal expansion.

However, during the palatal expansion process, the maxillary molars that receive the expansion forces from the palatal expander frequently exhibit buccal tipping, which can lead to inefficient or incomplete separation of the midpalatal suture. In many patients requiring palatal expansion, the central region of the palate is inherently constricted, and the left and right molars are already predisposed to buccal inclination; consequently, the application of additional expansion forces may exacerbate this inclination. Such increased tipping of the molars can result in deleterious outcomes, including deterioration of the occlusal relationship, damage to periodontal tissues, and resorption of tooth roots.

Additionally, human craniofacial bone structures exhibit characteristics whereby, with increasing age, mechanical interdigitation between the sutures formed between adjacent bones becomes more pronounced and overall bone density increases. These physiological changes function to strengthen the connections among the facial bones during the normal growth process, and the midpalatal suture is no exception. Consequently, in adults and adolescents, the resistance of the midpalatal suture to separation is significantly elevated, rendering effective expansion difficult to achieve through the application of forces generated solely by a palatal expander anchored to the maxillary left and right molars. Instead, such force application often results predominantly in undesirable outcomes, such as excessive buccal tipping of the maxillary molars. For this reason, in patients over approximately 18 years of age, “surgically assisted rapid palatal expansion” is commonly employed, wherein the bones in regions that resist expansion of the maxilla are surgically weakened by osteotomies prior to application of a palatal expander. However, this method has also been met with skepticism due to considerable associated burdens, including the need for general anesthesia, hospitalization costs, and extended postoperative recovery, as well as concerns regarding the long-term stability of the treatment outcomes.

In an effort to mitigate the aforementioned side effects associated with traditional palatal expanders, numerous clinical studies and trials have recently been conducted to more effectively deliver expansion forces by implanting orthodontic bone screws into the left and right cortical bone regions adjacent to the midpalatal suture. With advancements in dental implant technology, bone screws—essentially miniaturized forms of conventional dental implants—have been developed and incorporated into palatal expanders of the type described above, thereby enabling direct transmission of expansion forces to the skeletal structures and reducing reliance on dental anchorage.

However, palatal expanders employing bone screws also present certain limitations. In cases involving an extremely narrow palate, the main body of the palatal expander may interfere with the steeply sloped palatal anatomy, thereby hindering the ability to position the expander body as close to the palatal surface as desired. As a result, the distance between the main body of the palatal expander and the palatal surface—where the bone screws are to be implanted—increases, making it challenging to achieve stable implantation of the bone screws to a sufficient depth. Furthermore, even if the bone screws are implanted deeply, inadequate adaptation of the expander body to the palatal surface increases the effective lever arm of the mini-screws in proportion to the intervening gap. This, in turn, amplifies lateral forces acting on the mini-screws during expansion, impeding the efficient transmission of expansion forces to the midpalatal suture. Consequently, bone screws are prone to buckling or tilting under such conditions, which may ultimately lead to loosening or complete failure of the anchorage.

Most conventional palatal expanders employing bone screws are configured such that two bone screws are implanted on each of the left and right sides of the palate. If these bone screws buckle, tilt, or ultimately fail under the applied expansion forces, the forces generated by the palatal expander are instead transmitted to the left and right maxillary molars. Consequently, undesirable buccal tipping of these molars occurs, leading to severe outward inclination. Such conditions result in complications including deterioration of the occlusal relationship, damage to the alveolar bone, and resorption of the tooth roots, which represent well-known side effects associated with existing palatal expanders. Accordingly, there exists a need for the development of a structurally improved palatal expander capable of enhancing the support and stability provided by the bone screws, thereby improving the effectiveness and predictability of palatal expansion.

As described above, conventional palatal expanders possess several inherent limitations. To overcome these shortcomings, the inventor has fundamentally redesigned the palatal expander, configuring its structure such that even a device with a narrow width can achieve a sufficiently wide expansion by rotating the expansion mechanism 90 degrees relative to the traditional expansion direction. This structural modification allows the palatal expander to be positioned deeply against the palatal surface, even in patients with a narrow palate, and facilitates the simultaneous placement of three or more bone screws into the expander body. Consequently, the expansion force can be effectively transmitted to the midpalatal suture—the target tissue—solely through the bone screws, without dependence on dental anchorage.

This palatal expander is configured to be implanted in close proximity to the palatal surface, even in cases presenting with a narrow palate, thereby minimizing the lever arm of the bone screws. It further incorporates a structure that permits the implantation of three or more bone screws, enabling stable and direct transmission of expansion forces to the midpalatal suture, which is the primary target tissue for palatal expansion. Through this structural configuration, the expansion efficiency of the palatal expander is markedly enhanced. Whereas conventional palatal expanders rely on applying forces to the left and right maxillary molars to effect palatal separation—often resulting in undesirable side effects on the teeth and alveolar bone—the palatal expander developed by the inventor transmits expansion forces directly to the left and right cortical bone regions adjacent to the midpalatal suture without engaging the dentition. As a result, this device effectively mitigates dental and alveolar complications and facilitates reliable palatal expansion not only in pediatric patients at the mixed dentition stage—where secure dental anchorage is inherently limited and conventional expanders are often ineffective—but also in adult patients over 18 years of age, in whom increased resistance of the midpalatal suture typically exacerbates the side effects associated with traditional palatal expansion methods.

Nonetheless, in certain patients—particularly adult men and women in their late twenties, thirties, or older—who exhibit elevated bone density in the maxilla and adjacent craniofacial structures as well as significantly increased bonding strength of the circum-maxillary sutures, instances of unsuccessful palatal expansion have been observed. Such failures are primarily attributed to buckling and overturning of the palatal expander and the bone screws under the heightened resistance presented by these anatomical conditions.

FIGS. 1A, 1B, 2A, and 2B are views illustrating the problems associated with the palatal expander EXP previously developed by the inventor.

FIG. 1A shows photographs illustrating the condition immediately following the installation of the palatal expander EXP, previously developed by the inventor, into the midpalatal suture region of a patient.

Referring to FIG. 1A, it can be observed that both the main body of the palatal expander EXP and the bone screws MSC are positioned in an upright orientation.

FIG. 1B presents a series of photographs illustrating the tilting phenomenon of the bone screws MSC that occurred during the installation and subsequent expansion of the palatal expander EXP, previously developed by the inventor, within the midpalatal suture region of a patient.

Referring to FIG. 1B, even though three or more bone screws MSC were stably implanted into the left and right cortical bone regions adjacent to the midpalatal suture, it can be observed that the intended effect of palatal expansion was not achieved. Specifically, the left and right bodies of the palatal expander EXP tilted outward, and buckling and overturning phenomena occurred as the bone screws MSC shifted and inclined toward the center while remaining implanted within the bone. When such conditions arise, localized stress within the adjacent cortical bone increases, leading to the formation of micro-fractures, which in turn exacerbate the inclination of the bone screws MSC and diminish their mechanical stability within the cortical bone. As this process advances, the bone screws MSC may ultimately detach from the cortical bone, becoming loose and eventually dislodging. Furthermore, as the left and right bodies of the palatal expander EXP continue to tilt laterally outward, the main body of the expander itself experiences overturning. In this process, the links connecting the left and right bodies of the palatal expander EXP to the driving unit that generates the expansion force become bent and deformed, thereby further aggravating the overturning phenomenon. As a result of this detrimental cycle, the expansion force exerted by the palatal expander EXP contributes primarily to deformation and overturning of the expander and buckling of the bone screws, rather than to the intended separation of the midpalatal suture. Consequently, the desired palatal expansion does not occur, and the therapeutic effect of the palatal expansion procedure is not realized.

The reason that buckling and overturning phenomena occur—manifesting as outward tilting of the left and right bodies of the palatal expander EXP under conditions where the midpalatal suture does not separate as intended due to resistance from the circum-maxillary sutures—is as follows.

FIG. 2A is a view illustrating the leverage effect resulting from a height differential between the driving unit DP and the bone screws MSC of the palatal expander EXP previously developed by the inventor, while FIG. 2B is a view illustrating the overturning (tilting) phenomenon of the expander body and the bone screws MSC attributable to this leverage effect.

Referring to FIG. 2A, the palatal expander EXP comprises a driving unit DP configured to exert an expansion force (“P” in FIG. 2A) and a body that transmits the expansion force generated by the driving unit DP to the left and right palatal bones adjacent to the midpalatal suture MP. A bone screw MSC is coupled to the body and serves to deliver the expansion force (“P” in FIG. 2A) to the left and right palatal bones of the midpalatal suture MP. However, because the driving unit DP is mounted on the body to which the bone screws MSC are attached, a vertical offset exists, creating a height difference hₚ relative to the bone tissue that generates resistance to the expansion force when the bone screws MSC are implanted. Consequently, as depicted in FIG. 2B, the expansion force produced by the driving unit DP induces a leverage effect arising from the height difference hₚ, resulting in an overturning (tilting) phenomenon during the process in which the bone screws MSC and the body spread laterally, as shown with arrowed labeled “P and the dotted lines.

For this reason, during activation of the palatal expander EXP—particularly in cases requiring the application of a sufficiently strong expansion force over an extended period, as in adult patients—there exists a significant likelihood that the body of the palatal expander EXP and the bone screws MSC will undergo buckling by bending laterally and will tilt due to overturning forces. This phenomenon is further exacerbated when the palatal bone into which the bone screws MSC are implanted is thin or exhibits poor bone quality. Although the leverage effect may be fundamentally mitigated by reducing the vertical distance between the driving unit DP and the body of the palatal expander EXP, there may be an inherent limitation to minimizing the height of the palatal expander EXP, as a minimum structural volume is required to maintain the mechanical stability of the device. Furthermore, to satisfy medical device commercialization standards, existing palatal expanders must be designed with a minimal volume and height sufficient to endure the forces necessary for effective palatal expansion while also minimizing foreign body sensation within the oral cavity.

### SUMMARY

According to one embodiment of the present disclosure, there is provided a palatal expander that is configured to ensure structural stability and enhance resistance to buckling and overturning following implantation into the palatine bone. Additional aspects will be set forth in part in the following description and, in part, will become apparent from the description or may be learned through practice of the embodiments presented herein.

According to an aspect, a palatal expander includes a pair of bone screw coupling units extending in one direction and arranged to face each other, and a driving unit disposed between the pair of bone screw coupling units, wherein each of the bone screw coupling units is provided with at least three bone screw holes, the bone screw holes are arranged in a crosswise manner on a plurality of virtual lines parallel to an extension direction of the corresponding bone screw coupling unit, and the pair of bone screw coupling units move in one direction as at least a portion of the driving unit moves in the other direction.

In one or more embodiments, a distance (W) between centers of the bone screw holes in a transverse direction may be in a range of 0.1 mm≤W≤3.0 mm.

In one or more embodiments, a distance (D) between centers of the bone screw holes in a longitudinal direction may be in a range of 1.0 mm≤D≤15.0 mm.

In one or more embodiments, an angle (θ) formed by centers of the three adjacent bone screw holes may be in a range of 5°≤θ≤175°.

In one or more embodiments, the palatal expander may further include bone screws configured to be coupled to the bone screw holes. The bone screw holes may each have a diameter of about 102 % to about 110 % of a diameter of the bone screw. The bone screws may each have a diameter of about 1.0 mm to about 2.5 mm. The bone screw holes may be arranged in a zigzag pattern, a trapezoidal pattern, or a random pattern. The palatal expander may be designed to be fixed to a bone within 4 mm from either side of a midpalatal suture (MPS).

In one or more embodiments, the driving unit may be disposed between the pair of bone screw coupling units in parallel with them, and may include a screw rod having two types of screw threads formed in opposite directions, one type on one side and the other type on the other side. The screw rod may further include a hexagonal nut forming unit located between one end and the other end thereof.

In one or more embodiments, a palatal expander includes a pair of bone screw coupling units extending in an extension direction and arranged to face each other, and a driving unit disposed between the pair of bone screw coupling units. Each of the bone screw coupling units includes at least three bone screw holes, and the at least three bone screw holes are arranged in a crosswise manner in a transverse direction on a plurality of virtual lines parallel to the extension direction of a corresponding bone screw coupling unit. The transverse direction is perpendicular to the extension direction of each bone screw coupling unit. The pair of bone screw coupling units is configured to move in a first direction as at least a portion of the driving unit moves in a second direction.

In one or more embodiments, the at least three bone screw holes comprise a first group of bone screw holes and a second group of bone screw holes, and a distance (W), in the transverse direction, between centers of each bone screw hole in the first group and each bone screw hole in the second group is in a range of 0.1 mm≤W≤3.0 mm.

In one or more embodiments, a distance (D), in a longitudinal direction, between centers of two neighboring bone screw holes among the at least three bone screw holes is in a range of 1.0 mm≤D≤15.0 mm, where the longitudinal direction is parallel to the extension direction of each bone screw coupling unit.

In one or more embodiments, the at least three bone screw holes comprise a first bone screw hole, a second bone screw hole and a third bone screw hole arranged side by side in the extension direction and the second bone screw hole is arranged between the first bone screw hole and the third bone screw hole in the extension direction. The plurality of virtual lines comprises a first virtual line and a second virtual line, and each center of the first and the third bone screw hole is on the first virtual line and a center of the second bone screw hole is on the second virtual line. An angle (θ) formed when connecting the centers of the first and third bone screw holes from the center of the second bone screw hole is in a range of 5°≤θ≤175°.

In one or more embodiments, at least three bone screws configured to be coupled to the bone screw holes. Each bone screw hole has a diameter of about 102 % to about 110 % of a diameter of each bone screw. Each bone screw has a diameter of about 1.0 mm to about 2.5 mm.

The at least three bone screw holes are arranged in a zigzag pattern, a trapezoidal pattern, or a random pattern. The palatal expander is designed to be fixed to a bone within a predetermined distance from either side of a midpalatal suture (MPS), and the predetermined distance includes about 4 mm.

In one or more embodiments, the driving unit is disposed between the pair of bone screw coupling units, and the driving unit includes a screw rod having two types of screw threads formed in opposite directions, a first type of screw threads on a first side and a second type of screw threads on a second side. The screw rod further includes a hexagonal nut forming unit located between the first type of the screw threads and the second type of the screw threads.

### BRIEF DESCRIPTION OF THE DRAWINGS

The above and other aspects, features, and advantages of certain embodiments of the disclosure will be more apparent from the following description taken in conjunction with the accompanying drawings, in which:

FIGS. 1A, 1B, 2A, and 2B are views for explaining problems of a palatal expander in the art;

FIG. 1A illustrates one example of a palatal expander in the prior art;

FIG. 1B illustrates another example of a palatal expander in the prior art;

FIG. 2A illustrates a high differential of a palatal expander in the prior art;

FIG. 2B illustrates overturning phenomenon of the palatal expander shown in FIG. 2A;

FIG. 3A is a plan view schematically illustrating a palatal expander according to an embodiment of the disclosure;

FIG. 3B is a side view schematically illustrating the palatal expander shown in FIG. 3A;

FIG. 3C is a front view schematically illustrating the palatal expander shown in FIG. 3A; and

FIG. 4 is a plan view illustrating a state in which the palatal expander of FIGS. 3A to 3C is properly installed in the midpalatal suture of the palate in a mouth.

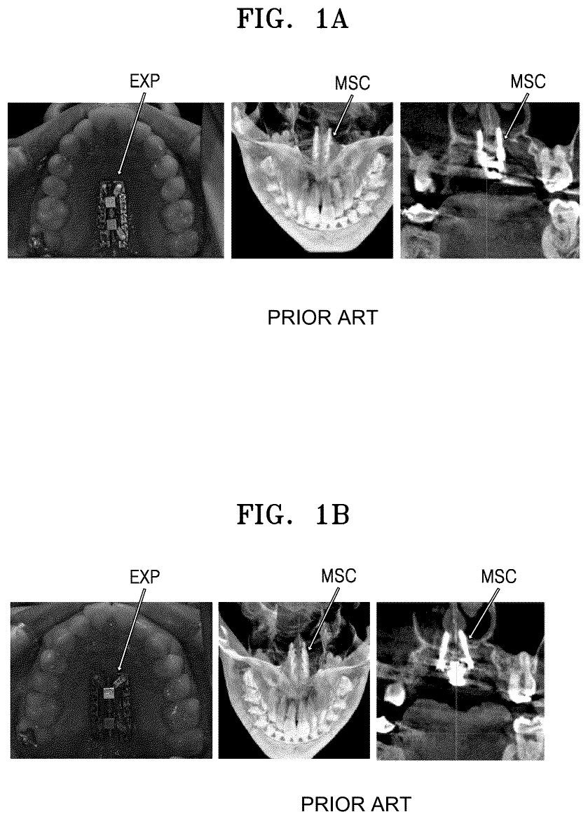

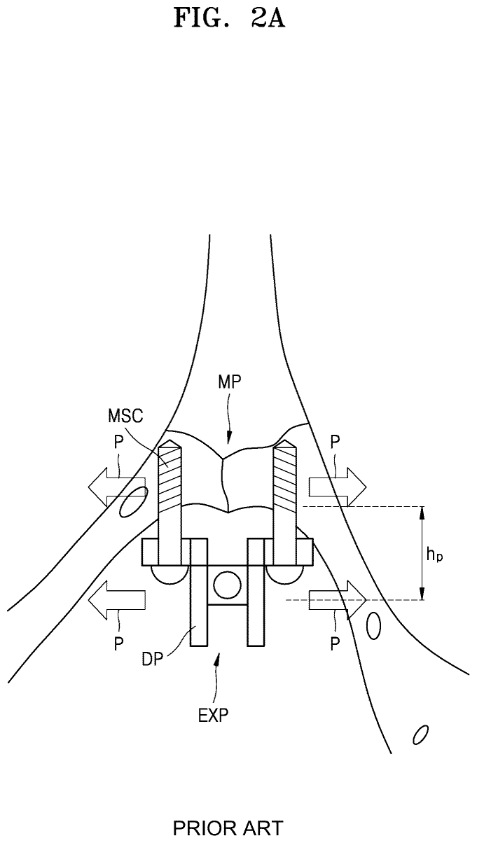

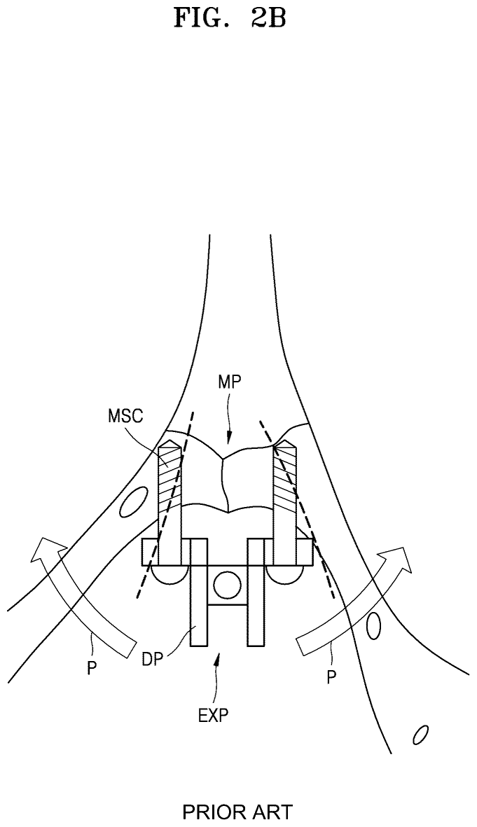

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects. As used herein, the term “and/or” includes any and all combinations of one or more of the associated listed items. Expressions such as “at least one of,” when preceding a list of elements, modify the entire list of elements and do not modify the individual elements of the list.

In order to prevent buckling and overturning phenomena in which the body and bone screw of a palatal expander tilt left and right due to a leverage effect occurring when the palatal expander operates, methods of improving a supporting force by changing the shape of the bone screw itself implanted in the body (i.e., bone screw coupling unit) may be considered. These methods may be divided into a method of increasing the diameter of the bone screw and a method of increasing the length of the bone screw.

First, a method of increasing a diameter of the bone screw is described as follows. As the diameter of the bone screw increases, the cross-sectional area of the bone screw implanted in the bone increases, and theoretically, the supporting force increases in proportion to the square of a diameter. However, there may be a limitation in increasing the diameter of the bone screw. In the case of a patient having a narrow palate, a space for implanting bone screws in the left and right sides of a midpalatal suture is limited, and bone screws having an excessively large diameter may cause excessive damage to a bone tissue during an implanting process.

Second, a method for increasing the length of the bone screw is described as follows. By increasing the length of the bone screw, resistance to buckling and overturning in the direction in which the implanted bone screw may dislodge can be enhanced. However, due to the anatomical characteristics of the region in which the bone screws are implanted, the thickness of the palatine bone varies among patients, yet remains subject to inherent anatomical limits within the human body. When a bone screw is implanted to a depth exceeding the thickness of the palatine bone, the portion of the bone screw extending beyond the palatine bone does not contribute to enhancing resistance against lateral forces. Moreover, it is generally recommended that bone screws utilized in conjunction with a palatal expander be implanted to a depth corresponding to the actual thickness of the palatine bone. Accordingly, increasing the length of the bone screw is unlikely to serve as an effective method for improving support against such lateral forces.

As a more effective improvement to address these drawbacks, consideration may be given to a method of enhancing resistance of a palatal expander body to buckling and overturning in the lateral direction—namely, the direction in which the body tends to tilt left and right—by adjusting the implantation arrangement of the bone screws.

That is, when the palatal expander is viewed from above, arranging the bone screws in a staggered configuration—as opposed to the conventional arrangement in a single row—can enhance resistance to buckling and overturning. This structural arrangement may improve the stability of the bone screws and the body (serving as a coupling unit) of the palatal expander fixed by the bone screws, thereby mitigating tilting to the left and right when lateral forces are applied.

When the palatal expander is actuated under identical conditions, arranging three or more bone screws in a staggered configuration, as opposed to a single row, may further enhance resistance to buckling and overturning induced by lateral forces, thereby more effectively preventing the palatal expander body from tilting.

Hereinafter, a palatal expander according to embodiments of the disclosure will be described in detail with reference to the drawings.

As used herein, the “transverse direction” refers to a direction perpendicular to the extension direction of a bone screw coupling unit. As used herein, the “longitudinal direction” refers to a direction parallel to the extension direction of a bone screw coupling unit.

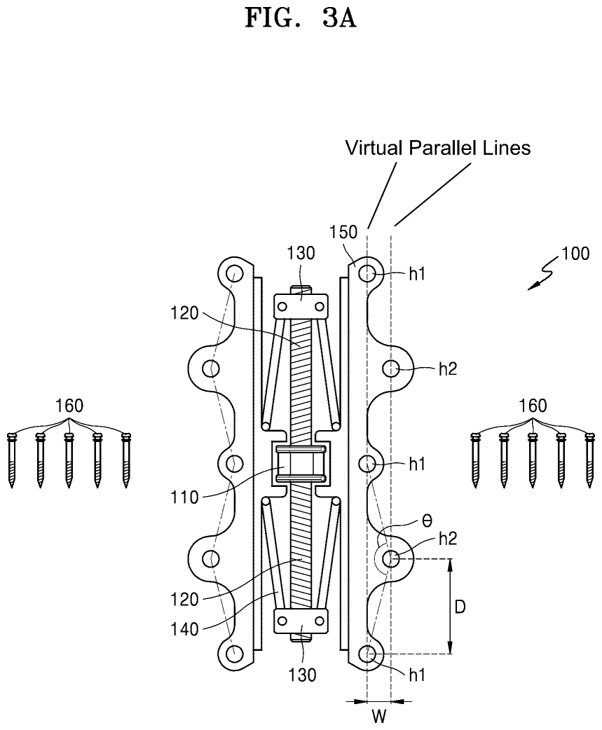

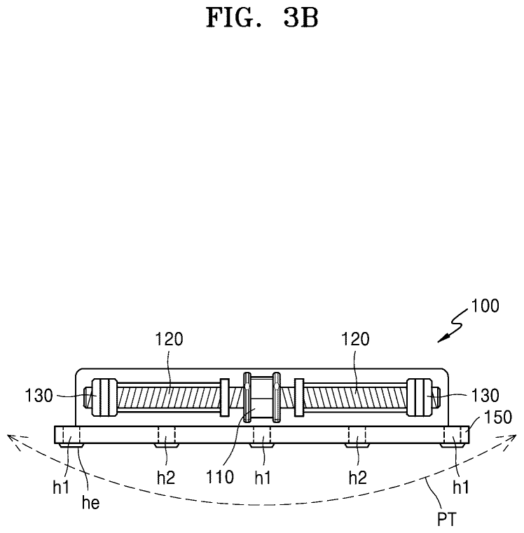

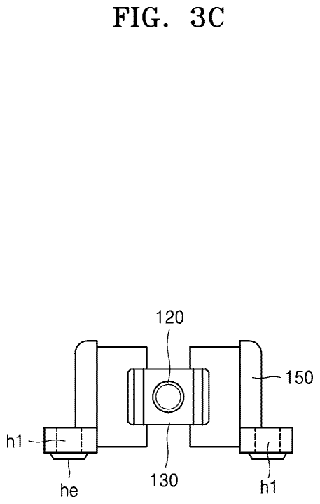

FIGS. 3A to 3C are views for explaining a palatal expansion device 100 according to an embodiment of the disclosure. FIG. 3A is a plan view schematically illustrating a palatal expander 100 according to one or more embodiments of the disclosure, FIG. 3B is a front view schematically illustrating a palatal expander 100 shown in FIG. 3A, and FIG. 3C is a side view schematically illustrating a palatal expander 100 shown in FIG. 3A.

Referring to FIGS. 3A to 3C, a palatal expander 100 according to an embodiment of the disclosure includes a hexagonal nut forming unit 110, a screw rod 120, a pair of link coupling units 130, at least one pair of links 140, a pair of bone screw coupling units 150, a plurality of bone screws 160, and a hexagonal wrench key (not shown) for rotating the hexagonal nut forming unit 110.

In one or more embodiments, the hexagonal nut forming unit 110 and the screw rod 120 having screw threads, coupled to the hexagonal nut forming unit 110 and formed opposite to each other, are arranged between the pair of bone screw coupling units 150 to be described later in parallel to the pair of bone screw coupling units 150. For example, the hexagonal nut forming unit 110 is placed at the center of the screw rod 120, first screw threads are placed on a left side of the hexagonal nut forming unit 110, second screw threads in the opposite direction to the first screw threads are placed on the right side of the hexagonal nut forming unit 110, and the lengths of the first screw threads may be equal to the lengths of the second screw threads in some embodiments. When the hexagonal wrench key (not shown) to be described later is inserted into a hexagonal nut, and force is applied to the inserted key in one direction, the hexagonal nut forming unit 110 rotates. The rotational force of this hexagonal nut forming unit 110 is directly transmitted to each screw rod 120 to be described later.

The screw rod 120 is placed between the pair of bone screw coupling units 150 in parallel to the pair of bone screw coupling units 150. Additionally, when the hexagonal nut forming unit 110 rotates in one direction, each screw rod 120 also rotates in the same direction as the rotational direction of the hexagonal nut forming unit 110. Each screw rod 120 receives the rotational force of the hexagonal nut forming unit 110 and retransmits it to the female screws of each corresponding link coupling unit 130 to be described later through the male screws of the screw rod 120. At this time, since the threads of the male screws on both sides of the screw rod 120 are formed in directions opposite to each other, when the screw rod 120 rotates in one direction, the respective corresponding link coupling units 130 move in a direction closer to or farther away from each other. Through this process, each corresponding link coupling unit 130 converts the rotational motion of the hexagonal nut forming unit 110 transmitted to each screw rod 120 into a linear motion of the link coupling unit 130, and then transmits a force to each link 140 to be described later.

The pair of link coupling units 130 are each screwed into one of the two types of screw threads formed on the screw rod 120. That is, each of the pair of link coupling units 130 includes female screws capable of being coupled to each of the two types of screw threads formed on the screw rod 120.

One end of each link 140 is rotatably coupled to each corresponding link coupling unit 130, and the other end thereof is rotatably coupled to each corresponding bone screw coupling unit 150. For example, one end of each link 140 may be rotatably coupled to each corresponding link coupling unit 130, and the other end thereof may be rotatably coupled to each corresponding bone screw coupling unit 150 to face the end of the hexagonal nut forming unit 110 or the screw rod 120. Additionally, the angle between each link 140 and each screw rod 120 is variable within a range of about 0° to about 90°. Accordingly, when the hexagonal nut forming unit 110 rotates in one direction, each screw rod 120 rotates in the same direction as the rotational direction of the hexagonal nut forming unit 110, the respective corresponding link coupling units 130 moves in a direction closer to or farther away from each other, and each link (140) moves in a direction in which the angle between the link 140 and the screw rod 120 increases. Each link 140 plays a role of transmitting a rotational force of the hexagonal nut forming unit 110 to the female screws of each corresponding link coupling unit 130 through the male screws of the screw rod 120, thereby causing a horizontal movement in which the link coupling units 130 move in a direction closer to or farther away from each other, and retransmitting the force to the bone screw coupling units 150 to move in a direction farther away from each other. The pair of bone screw coupling units 150 are arranged to face each other and are extended in one direction.

Additionally, each of the pair of bone screw coupling units 150 has at least three bone screw holes h1 and h2 formed therein. The plurality of bone screw holes h1 and h2 may be arranged in a crosswise manner on a plurality of virtual parallel lines parallel to the extension direction of each corresponding bone screw coupling unit 150, as shown in FIG. 3A.

In one or more embodiments, the distance W between centers of the bone screw holes h1 and h2 in a transverse direction may be in a range of 0.1 mm≤W≤3.0 mm by way of example. Additionally, the distance D between centers of the bone screw holes h1 and h2 in a longitudinal direction may be, for instance, in a range of 1.0 mm≤D≤15.0 mm. Additionally, the angle (θ) formed by centers of the adjacent three bone screw holes h1 and h2 may be, for instance, in a range of 5°≤θ≤175°.

Additionally, the palatal expander 100 may further include the bone screws 160 configured to be coupled to the bone screw holes h1 and h2. Additionally, each of the bone screw holes h1 and h2 may have a diameter of about 102 % to about 110 % of a diameter of each of the bone screws 160. For instance, each of the bone screws 160 may have a diameter of about 1.0 mm to about 2.5 mm.

In one or more embodiments, the bone screw holes h1 and h2 may be arranged in a zigzag pattern, a trapezoidal pattern, or a random pattern. These patterns are by way of example only and the present disclosure may not be limited thereto.

When the bone screws 160 are considered as cylindrical columns, the arrangement of them in a row and the arrangement of them in a crosswise manner may be compared in terms of an increase in resistance to a lateral force. Crosswise arrangement distributes a force over a wider area compared to when columns are aligned in a single row, and are structurally stronger because each column distributes the force at a different angle from each other when a lateral force is applied. Additionally, the columns arranged in a row are more likely to buckle (bend) or overturn (fall over) in the same direction, whereas the crosswise arrangement allows each column to act as a support for the others, thereby distributing a lateral force more easily

The reason for an increase in resistance to a lateral force is due to a load distribution effect and as tilt stabilization effect. In the crosswise arrangement, the lateral force entirely distributes without concentrating on a specific column, and when the interval and arrangement angle between the columns are designed appropriately, the resistance to a lateral force may further increase. Additionally, the crosswise arrangement may prevent a force from being concentrated in one direction and make a force transmission path between the columns more efficient, thereby increasing resistance.

To maximize these effects, the interval and angulation between the columns must be appropriately configured, as excessively wide or narrow intervals may diminish the intended benefits. Additionally, the fixation method of each column must ensure sufficient coupling strength between the columns to fully leverage the advantages of the staggered arrangement.

When columns are arranged in the crosswise arrangement, resistance to a lateral force increases because a force distributes and structural stability improves. The specific degree of increase in resistance to a lateral force may vary depending on arrangement, interval between columns, material properties, and completeness of a coupling structure. The relationship between the left-right width W of the columns arranged in a crosswise manner columns and the resistance (R) to a lateral force may be expressed as a nonlinear relationship in which the resistance increases as the arranged width increases, as represented by Equation 1 below.

### [Equation 1]

R=R₀+k·Wₙ

Here, R refers to a total resistance to a lateral force, R₀ refers to a reference resistance, k refers to a proportional constant reflecting material properties and interval between columns, W refers to a left-right width in crosswise arrangement, and n refers to an index representing a nonlinear increase (generally 1<n<2).

As W increases, a force distributes and resistance (R) increases, but the degree of increase in the resistance (R) tends to become more gradual as the width increases. In addition, since crosswise arrangement has a greater force distribution effect than arrangement in a row, k and R₀ values tend t o be higher, and exact values need to be adjusted based on experimental or simulation data.

When this design is applied to the palatal expander 100, resistance to lateral force may increase compared to arrangement in a row by arranging three or more bone screws 160 coupled to the body of the palatal expander 100 in a crosswise manner. Accordingly, an overturning phenomenon of the body tilting left and right due to a leverage occurring while the palatal expander 100 is actuated may be improved, and resistance to a buckling phenomenon in which bone screws bend may also be increased. Even in the case of adult patients with high resistance to palatal expansion or in the case where the bone thickness or bone quality of the area where the bone screw 160 is implanted is thin or weak, the load against the lateral force is distributed widely compared to when the bone screws 160 are implanted in a row, thereby preventing the overturning of the left and right bodies of the palatal expander 100 and the deformation of the links and simultaneously enabling the effective expansion of the palatal expander 100.

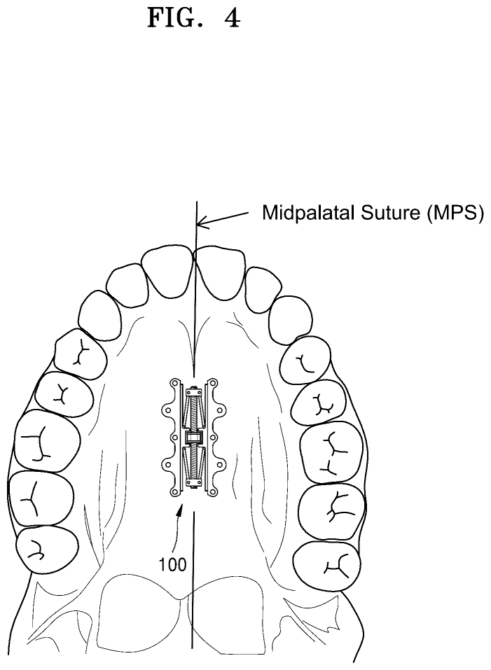

Additionally, each corresponding bone screw coupling unit 150 is coupled to one or more links 140. Accordingly, when the hexagonal nut forming unit 110 rotates in one direction, each screw rod 120 rotates in the same direction as the rotational direction of the hexagonal nut forming unit 110, each corresponding link coupling unit 130 moves in a direction closer to or farther away from the center of the hexagonal nut forming unit 110, each link 140 rotates in a direction in which the angle between the link 140 and each screw rod 120 increases, and each corresponding bone screw coupling unit 150 moves to be away from each screw rod 120 in a direction perpendicular to the lengthwise direction of each screw rod 120. In this way, each corresponding bone screw coupling unit 150 serves to retransmit the rotational force of the hexagonal nut forming unit 110 transmitted to each link 140 to each bone screw 160 implanted in the palatine bone. The force retransmitted to each bone screw 160 in this way is ultimately transmitted to the bone (not shown) adjacent to the midpalatal suture of the palate in which each bone screw 160 is implanted, thereby separating the midpalatal suture (MPS of FIG. 4) in both directions to expand the palate.

The hexagonal wrench key (not shown) is coupled to the outer circumferential surface of each hexagonal nut forming unit 110 to rotate the hexagonal nut forming unit 110 in one direction.

As shown in FIG. 3A, the pair of link coupling units 130 are screw-connected to one end and the other end of the screw rod 120 placed far from the hexagonal nut forming unit 110, and one end of each link 140 is rotatably coupled to each corresponding link coupling unit 130 and the other end thereof is rotatably coupled to the bone screw coupling unit 150 to face the hexagonal nut forming unit 110. However, the present disclosure is not limited thereto, and the palatal expander 100 is configured such that the pair of link coupling units 130 are screw-connected to a part and the other part of the screw rod 120 placed near the hexagonal nut forming unit 110, and one end of each link 140 is rotatably coupled to each corresponding link coupling unit 130 and the other end thereof is rotatably coupled to the bone screw coupling unit 150 to face one or the other end of the screw rod 120.

In addition, similarly to the shape of the palate PT indicated by a dotted line in FIG. 3B, each corresponding bone screw coupling unit 150 may have an arch-shaped bottom that is thick in the center along a length direction and becomes thinner toward both ends. The more the shape of each corresponding bone screw coupling unit 150 resembles the cross-sectional shape of the palate PT, when the bone screw coupling unit 150 is fixed to the bone at the midline of the palate PT by each bone screw 160 and an expansion force is exerted, the length of the lever arm in the bone area supporting the expansion force is shortened, so that the expansion force of the palatal expander 100 is stably transmitted to the bone through the bone screws 160, and the generation of leverage forces that could cause the bone screws 160 to fall out is reduced.

As shown in FIGS. 3B and 3C, at the base of the bone screw hole h1 or h2 formed in each corresponding bone screw coupling unit 150, i.e., at the surface facing a soft tissue, the exit of the bone screw hole h1 or h2 may be formed in a funnel shape extending downward, so that the area where the palatal expander 100 including each corresponding bone screw coupling unit 150 directly contacts the soft tissue is restricted to the area around the bone screw hole h1 or h2 through which the bone screw 160 passes. Thus, it is possible to prevent inflammation and pain due to palatal mucosa ulcer that may occur when other parts of the palatal expander 100 come into contact with the underlying soft tissue.

FIG. 4 is a plan view illustrating a state where the palatal expander of FIGS. 3A to 3C is installed near a midpalatal suture (MPS) of a palate in a mouth. Specifically, the palatal expander 100 is symmetrically placed left and right with respect to the midpalatal suture (MPS) as a center.

Referring to FIG. 4, the palatal expander 100 has a sufficiently narrow transverse width, so that it may be easily used even in a narrow palate. Additionally, the palatal expander 100 can be fixed to left and right regions placed 4 mm from either side of the midpalatal suture (MPS) where appropriate bone fixation is possible. Additionally, the palatal expander 100 has a narrow transverse width, but has an expansion range of motion wider than the transverse width of the palatal expander 100 according to a treatment purpose. As used herein, the term “minimum transverse width of the palatal expander” refers to a transverse width of the palatal expander before palatal expansion, and the term “maximum transverse width of the palatal expander” refers to a transverse width of the palatal expander after palatal expansion in maximum range.

Since the palatal expander 100 according to an embodiment of the disclosure has a different force transmission direction from conventional palatal expanders, the expansion range of the palatal expander 100 is determined by the length of the palatal expander 100, not the width of the palatal expander 100, that is, the length of the screw rod 120. In addition, the palatal expander 100 may be equipped with a number of bone screws (10 in the case of FIG. 4), so that sufficient supporting force of the bone screws can be obtained when it is used for palatal expansion.

In addition, the palatal expander 100 according to an embodiment of the present disclosure may be easy to install because the transverse width of the palatal expander 100 is narrower than that of a conventional palatal expander, has a wide expansion range despite the narrow transverse width of the palatal expander 100, does not cause a fall-out due to the generation of a leverage force of the bone screws 160 because the distance from the bone is close, and can obtain a sufficient palatal expansion effect without applying a force to the molars MT.

The driving unit provided in the palatal expander 100 can move the pair of bone screw coupling units 150 such that the interval therebetween widens at one side and becomes wider at the other side. In this case, the screw rod 120 may include two types of screw threads formed in directions opposite to each other and having different slopes and intervals from each other. Additionally, in this case, the pair of link coupling units 130 may include female screw threads having different slopes and intervals from each other.

Although preferred embodiments of the disclosure have been described above with reference to the drawings, these are merely exemplary, and those skilled in the art will understand that various modifications and equivalent other embodiments are possible. Accordingly, the scope of protection of the disclosure should be defined by the appended claims.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A palatal expander comprising:
a pair of bone screw coupling units extending in an extension direction and arranged to face each other; and
a driving unit disposed between the pair of bone screw coupling units,
wherein each of the bone screw coupling units includes at least three bone screw holes, and the at least three bone screw holes are arranged in a crosswise manner in a transverse direction on a plurality of virtual lines parallel to the extension direction of a corresponding bone screw coupling unit, and wherein the transverse direction is perpendicular to the extension direction of each bone screw coupling unit; and
the pair of bone screw coupling units is configured to move in a first direction as at least a portion of the driving unit moves in a second direction.

2. The palatal expander of claim 1,
wherein the at least three bone screw holes comprise a first group of bone screw holes and a second group of bone screw holes, and
wherein a distance (W), in the transverse direction, between centers of each bone screw hole in the first group and each bone screw hole in the second group is in a range of 0.1 mm≤W≤3.0 mm.

3. The palatal expander of claim 1,
wherein a distance (D), in a longitudinal direction, between centers of two neighboring bone screw holes among the at least three bone screw holes is in a range of 1.0 mm≤D≤15.0 mm, wherein the longitudinal direction is parallel to the extension direction of each bone screw coupling unit.

4. The palatal expander of claim 1, wherein:
the at least three bone screw holes comprise a first bone screw hole, a second bone screw hole and a third bone screw hole arranged side by side in the extension direction and the second bone screw hole is arranged between the first bone screw hole and the third bone screw hole in the extension direction;
the plurality of virtual lines comprises a first virtual line and a second virtual line, and each center of the first and the third bone screw hole is on the first virtual line and a center of the second bone screw hole is on the second virtual line; and
an angle (θ) formed, when connecting the centers of the first and third bone screw holes from the center of the second bone screw hole, is in a range of 5°≤θ≤175°.

5. The palatal expander of claim 1, further comprising:
at least three bone screws configured to be coupled to the at least three bone screw holes.

6. The palatal expander of claim 1,
wherein each bone screw hole has a diameter of about 102 % to about 110 % of a diameter of each bone screw.

7. The palatal expander of claim 6,
wherein each bone screw has a diameter of about 1.0 mm to about 2.5 mm.

8. The palatal expander of claim 1,
wherein the at least three bone screw holes are arranged in a zigzag pattern, a trapezoidal pattern, or a random pattern.

9. The palatal expander of claim 1,
wherein the palatal expander is designed to be fixed to a bone within a predetermined distance from either side of a midpalatal suture (MPS), and the predetermined distance includes about 4 mm.

10. The palatal expander of claim 1,
wherein the driving unit is disposed between the pair of bone screw coupling units, and the driving unit includes a screw rod having two types of screw threads formed in opposite directions, a first type of screw threads on a first side and a second type of screw threads on a second side.

11. The palatal expander of claim 10,
wherein the screw rod further includes a hexagonal nut forming unit located between the first type of the screw threads and the second type of the screw threads.
